(19) United States
(12) Patent Application Publication
(10) Pub. No.: US 2003/0004440 A1
(43) Pub. Date: Jan. 2, 2003

(54) Apparatus and method for monitoring performance of minimally invasive direct cardiac compression

(76) Inventors: Rodney A. Brenneman, San Juan Capistrano, CA (US); Reynaldo B. Halili JR., Carlsbad, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/895,844

(22) Filed: Jun. 29, 2001

(51) Int. Cl. A61H 1/00

(52) U.S. Cl. 601/15

(57) ABSTRACT

The present invention provides devices and methods for monitoring performance of minimally invasive direct cardiac massage. In particular, the present invention provides devices and methods which greatly facilitate proper performance of minimally invasive direct cardiac compression. Devices according to the present invention may comprise a handle, having a proximal end and a distal end, a structure attached to a distal end of the handle adapted to contact the pericardium or other heart surface to compress the heart, and a force transducer coupled to the handle and/or the structure to produce a signal which corresponds to an amount of force applied through the handle to the heart. A signal processor receives the force transducer signal and produces an output corresponding to the applied force. A display receives the output of the signal processor and produces a human decipherable indication based on the applied force.

### BACKGROUND OF THE INVENTION

1. Field of the Invention

The present invention relates generally to medical devices and methods. More particularly, the present invention relates to devices and methods for monitoring performance of minimally invasive direct cardiac massage.

Sudden cardiac arrest is a leading cause of death in most industrial societies. While in many cases it is theoretically possible to re-establish cardiac function, irreversible damage to vital organs, particularly the brain and the heart itself, will usually occur prior to restoration of normal cardiac activity.

A number of techniques have been developed to provide artificial circulation of blood to oxygenate the heart and brain during the period between cardiac arrest and restoration of normal cardiac activity. Prior to the 1960's, open chest cardiac massage (OCM) was a standard treatment for sudden cardiac arrest. Open chest cardiac massage, as its name implies, involved opening a patient's chest and manually squeezing the heart to pump blood to the body. In the 1960's, closed chest cardiac massage (CCM) where the heart is externally compressed through the chest wall became the standard of treatment. When CCM is combined with airway support, it is known as cardiopulmonary resuscitation (CPR). CPR has the advantage that it is much less invasive than OCM and can be performed by less skilled individuals. It has the disadvantage, however, that it is not generally effective. In particular, the medical literature shows that CCM provides significantly less cardiac output, neuroperfision, and cardiac perfusion than achieved with OCM.

Of particular interest to the present invention is the recent introduction of devices for performing minimally invasive direct cardiac massage. Such devices and methods are described in co-pending application Ser. Nos. 09/087,665 filed May 29, 1998, now U.S. Pat. No. 6,200,280; 60/111,934 filed Dec. 11, 1998 (now abandoned); 09/344,440 filed Jun. 25, 1999; 09/356,064 filed Jul. 19, 1999; and 09/801,421 filed Mar. 7, 2001, assigned to the assignee of the present application. The full disclosures of each of the these prior patents and application are incorporated herein by reference. Generally, such methods rely on introducing a plurality of struts, an expansible flared bell structure, a laterally oriented expansible structure, or other expandable member to engage the heart through a small incision through an intercostal space to a region over the pericardium or other heart surface. The heart may then be pumped by directly engaging the deployed expansible structure against the pericardium to repeatably compress the heart, typically by reciprocating a shaft attached to the member. Additional minimally invasive direct cardiac massage devices and methods are also described in U.S. Pat. Nos. 5,582,580; 5,571,074; and 5,484,391 issued to Buckman, Jr. et al. and U.S. Pat. Nos. 5,931,850; 5,683,364; and 5,466,221 issued to Zadini et al., licensed to the assignee of the present application. While direct cardiac massage approaches offer great promise, certain shortcomings still exist. For example, it is sometimes difficult to determine whether appropriate compressive forces have been applied to a patient's heart, particularly by less skilled treating individuals. This is a particular problem when the users are familiar with closed chest CPR where significantly greater force is required.

For these reasons, it would be desirable to provide devices and methods for monitoring performance of minimally invasive direct cardiac massage. In particular, it would be desirable to provide devices and methods which facilitate proper application of minimally invasive direct cardiac compression. The devices and methods should give a perceptible indication when appropriate compression forces are applied, in order to eliminate the possibility that insufficient or excessive compression strokes are being applied during a given procedure. It would be further desirable if such devices may be used by person of minimal experience or training, while still allowing for control and optimization of cardiac massage performance. The devices and methods should be simple and less costly to manufacture and produce and impart an enhanced tactile feel to a user of the device. At least some of these objectives will be met by the invention described hereinafter.

2. Description of the Background Art

Devices and methods for controlled external chest compression utilizing a pressure indicator are described in U.S. Pat. Nos. 4,554,910 and 5,645,522, and in a brochure of AMBU International A/S, Copenhagen, Denmark, entitled Directions for Use of AMBU® Cardiopump™, published in September 1992. Devices and methods for minimally invasive direct cardiac massage through intercostal dissection are described co-pending U.S. patent application Ser. No. 09/087,665 filed May 29, 1998, now U.S. Pat. No. 6,200,280; U.S. Provisional Patent Application No. 60/111,934 filed Dec. 11, 1998 (now abandoned); U.S. patent application Ser. Nos. 09/344,440 filed Jun. 25, 1999; 09/356,064 filed Jul. 19, 1999; and 09/801,421 filed Mar. 7, 2001, assigned to the assignee of the present application. U.S. Pat. Nos. 5,484,3915, 582,580; and 5,571,074 to Buckman, Jr. et al. and U.S. Pat. Nos. 5,466,221 and 5,683,364 to Zadini et al., licensed to the assignee of the present application, also describe devices and methods for minimally invasive direct cardiac massage through an intercostal space. Published PCT Application No. WO 98/05289 and U.S. Pat. No. 5,385,528 describe an inflatable device for performing direct cardiac massage. Devices and methods for establishing intercostal access are described in co-pending U.S. patent application Ser. No. 09/768,041 (Attorney Docket No. 018803-001700US), assigned to the assignee of the present application. U.S. Pat. No. 3,496,932 describes a sharpened stylet for introducing a cardiac massage device to a space between the sternum and the heart. Cardiac assist devices employing inflatable cuffs and other mechanisms are described in U.S. Pat. Nos. 5,256,132; 5,169,381; 4,731,076; 4,690,134; 4,536,893; 4,192,293; 4,048,990; 3,613,672; 3,455,298; and 2,826,193. Dissectors employing inflatable components are described in U.S. Pat. Nos. 5,730,756; 5,730,748; 5,716,325; 5,707,390; 5,702,417; 5,702,416; 5,694,951; 5,690,668; 5,685,826; 5,667,520; 5,667,479; 5,653,726; 5,624,381; 5,618,287; 5,607,443; 5,601,590; 5,601,589; 5,601,581; 5,593,418; 5,573,517; 5,540,711; 5,514,153; and 5,496,345. Use of a direct cardiac massage device of the type shown in the Buckman, Jr. et al. patents is described in Buckman et al. (1997) Resuscitation 34:247-253 and (1995) Resuscitation 29:237-248.

The full disclosures of each of the above references are incorporated herein by reference.

### BRIEF SUMMARY OF THE INVENTION

The present invention provides devices and methods for monitoring performance of minimally invasive direct cardiac massage. In particular, the present invention provides devices and methods which greatly facilitate proper performance of minimally invasive direct cardiac compression. Devices according to the present invention may comprise a handle having a proximal end and a distal end, a structure attached to a distal end of the handle adapted to contact the pericardium or other heart surface to compress the heart, and a force transducer coupled to the handle and/or structure to produce a signal which corresponds to an amount of force applied through the handle to the heart. A signal processor receives the force transducer signal and produces an output corresponding to the applied force. A display receives the output of the signal processor and produces a human decipherable indication based on the applied force.

The handle may be any assembly, system, or other mechanical framework which is suitable for positioning and manipulating the heart-engaging structure so that the structure can engage and compress the heart. Most simply, the handle could be a simple shaft or support having the heart-engaging structure attached to the distal end thereof. Once the structure engages the heart through a small incision through an intercostal space to a region over a pericardium, cardiac massage can be performed by simple manual pumping or reciprocation of the handle or shaft. A wide variety of other handles will also be possible, including handles which comprise powered drivers, such as electric, pneumatic, or other motors. Such drivers can be provided as part of the handle, where the driver may be disposed externally, internally, or both externally and internally relative to the patient when the structure contacts the pericardium.

The structure comprises an expandable surface, such as a plurality of struts, an expansible flared bell structure, a laterally oriented expansible structure, or other heart-engaging member that contacts the heart after being inserted through a small incision through an intercostal space. The expandable surface of the structure has a radially contracted configuration that permits intercostal passage and a radially expanded configuration for contacting the pericardium or other heart surface. In the radially contracted configuration, the expandable surface has a width no greater than 2 cm. The heart may then be pumped by directly engaging the opened struts or deployed structure against the pericardium to periodically compress the heart. Exemplary cardiac massage structures are described in co-pending U.S. patent application Ser. No. 09/087,665 filed May 29, 1998, now U.S. Pat. No. 6,200,280; U.S. Provisional Patent Application No. 60/111,934 filed Dec. 11, 1998 (now abandoned); U.S. patent application Ser. Nos. 09/344,440 filed Jun. 25, 1999; 09/356,064 filed Jul. 19, 1999; and 09/801,421 filed Mar. 7, 2001, assigned to the assignee of the present application. Other suitable cardiac massage structures are described in U.S. Pat. Nos. 5,484,391; 5,582,580; and 5,571,074 issued to Buckman, Jr. et al. and 5,931,850; 5,683,364; and 5,466,221 issued to Zadini et al., licensed to the assignee of the present application.

The force transducer may be a strain gauge, a piezoelectric crystal, photoelectric cell, thin wire, or the like. It will be appreciated that accelerometers and pressure transducers may also be suitable to determine force applications of the cardiac massage device. The force transducer may be positioned inside the handle or alternatively be externally connected to the handle to measure a force applied through the handle to the heart.

The signal processor, which receives the force transducer signal, will usually comprise a digital processor, an analog processor, or a high voltage amplifier. The signal processor may be powered by a battery or other suitable power source. The power source may be automatically turned on when the applied force exceeds a given threshold force, the threshold force ranging from 0.1 lbs. to 15 lbs., and automatically turned off after a period of device non-activity, typically after 15 minutes, so as to limit any wasted battery use.

The signal processor may comprise circuitry or software, such as EPROM and timer chips, that compares the applied force signal to an optimal force value and produces a feedback message to increase, decrease, or maintain the actual applied force. Optimal force application values for minimally invasive direct cardiac massage will preferably be in a range from 5 lbs. to 15 lbs., more preferably from 8 lbs. to 12 lbs. The circuitry or software may additionally convert the force transducer signal to a heart compression rate signal. The circuity may further compare the applied compression rate to an optimal compression rate value, and produce a feedback message to increase, decrease, or maintain the actual applied compression rate. Optimal compression rate values will preferably be in a range from 60 bpm (beats per minute) to 120 bpm, more preferably from 80 bpm to 100 bpm. In some instances, a multiple array of force transducers may be coupled to the handle to produce multiple force transducer signals. The signal processor in turn receives and processes such signals and produces a feedback message to adjust or maintain a location or angle of force application.

The display receives the feedback messages from the signal processor and produces a human decipherable indication based on the feedback messages to let the treating individual immediately know whether too high, too low, or acceptable force and/or compression rate is being applied, and/or whether the location and/or angle of force application is correct. It will be appreciated that the output from the signal processor may be displayed in any number of ways. For example, the human decipherable indication may be visual, such as LED (light emitting diode) lights, discrete value digital readouts, flashing lights, and the like. Alternatively, the human decipherable indication may be a sound system, such as an audible alarm, a pacing signal, or voice commands. Hence, the devices and methods of the present invention give a perceptible indication when appropriate compression forces and/or compression rates are applied, thereby minimizing the possibility that insufficient or excessive compression strokes are being applied during a given cardiac massage procedure. Another advantage of the present invention is that the device may be used by persons of minimal experience or training, while still allowing for control and optimization of cardiac massage performance by the treating person within the correct operating parameters (force, compression rate, etc.). Moreover, the use of such electronic monitoring provides an enhanced tactile feel to a treating person, as conventional mechanical gauges employing a compressible member often have a large compliance, thereby impeding any tactile feedback to an operator of the device.

The circuitry or software of the signal processor may further store data on at least one of applied force, compression rate, time intervals of device use, time intervals of device non-use, total time of device use, time of device use at a given force, and time of device use at a given compression rate. Typically, the circuitry or software samples the data to produce a reduced data set so as to maximize memory as the memory chips have limited memory due to device size constraints. The stored data may be transmitted via infra-red, magnetic means, hard wire means, or radio frequency to an external memory source, or the stored data may optionally be cleared by a reset button or switch. The device may further comprise an on/off trigger on the display.

In another aspect of the present invention, a minimally invasive direct cardiac massage device comprises a handle, a structure attached to one end of the handle adapted to non-traumatically engage a pericardium or other heart surface to compress the heart, and a force gauge coupled to the handle and/or the structure to monitor an amount of force applied through the handle to the heart. The force gauge may comprise an electrical force transducer, as described above, or a mechanical force gauge, such as a spring or other compressible member. The force gauge may be inside the handle or externally connected to the handle.

In a still further aspect of the present invention, methods for monitoring performance of minimally invasive direct cardiac massage are provided. One method comprises advancing a structure of the cardiac massage device through an intercostal space to a region over a pericardium. Usually, the device structure will have a low profile configuration when introduced through the intercostal space. After a distal tip of the device structure enters the region over the pericardium, the structure will be opened or expanded (optionally while the structure continues to be advanced). The structure on the cardiac massage device is engaged against the pericardium (via the opened structure) to periodically compress the heart. An amount of force applied through the structure to the heart is then monitored. Monitoring may be carried out electronically by a force transducer and a signal processor, or optionally by a mechanical force gauge.

In yet another aspect of the present invention, kits comprising a minimally invasive direct cardiac massage device and instructions on how to monitor performance of the device are provided. The cardiac massage device may comprise any of the structures described herein, while instructions for monitoring performance of the cardiac massage device will generally recite the steps for performing one or more of the above described methods. The instructions will often be printed, optionally being at least in-part disposed on packaging. The instructions may alternatively comprise a videotape, a CD-ROM or other machine readable code, a graphical representation, or the like showing any of the above described methods.

### BRIEF DESCRIPTION OF THE DRAWINGS

FIG. 1 is a perspective view of a minimally invasive direct cardiac massage device employing an electronic monitoring system constructed in accordance with the principles of the present invention.

FIG. 2A is a cross-sectional view the device handle of FIG. 1.

FIG. 2B is another cross-sectional view of the device handle of FIG. 1.

FIG. 3 is a top view of the device taken along line 3-3 in FIG. 1.

FIGS. 3A and 3B show alternate top views of the device similar to FIG. 3.

FIG. 4 is a flow chart illustrating an overview of the electronic monitoring system of the device of FIG. 1.

FIG. 5 is a circuit diagram of the electronic monitoring system of the device of FIG. 1.

FIG. 6 illustrates an alternate cardiac massage device employing a mechanical monitoring system.

FIG. 7 is a cross-sectional view illustrating a heart beneath a patient's rib cage.

FIGS. 8A and 8B illustrate a method according to the present invention employing the cardiac massage device of FIG. 1.

### DESCRIPTION OF THE SPECIFIC EMBODIMENTS

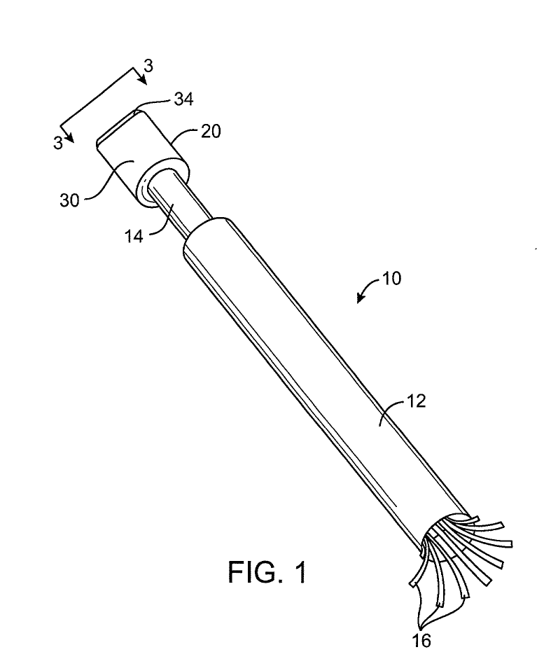

Referring now to FIG. 1, an exemplary device 10 constructed in accordance with the principles of the present invention generally comprises a shaft 14, a structure 16 attached to a distal end of the shaft adapted to contact the pericardium or other heart surface to compress the heart, and a force transducer 30 coupled to the proximal end of the shaft 14 to produce a signal which corresponds to an amount of force applied through the shaft 14 to the heart. A signal processor 32 receives the force transducer 30 signal and produces an output corresponding to the applied force. A display 34 receives the output of the signal processor 32 and produces a human decipherable indication based on the applied force. It will be appreciated that the following depictions are for illustration purposes only and does not necessarily reflect the actual shape, size, or dimensions of the minimally invasive direct cardiac massage device 10. This applies to all depictions hereinafter.

The device 10 will have a plurality of struts 16, as described in more detail in co-pending U.S. patent application Ser. Nos. 09/087,665 filed May 29, 1998, now U.S. Pat. No. 6,200,280 and U.S. patent application Ser. No. 09/344,440 filed Jun. 25, 1999, typically having at least 3 struts, usually having from 8 to 20 struts, preferably from 10 to 15 struts. The struts 16 are shown in FIG. 1 in a partially deployed configuration extending from a distal end of a sheath 12 which is coaxially received over the shaft 14. The struts 16 are retractable to a radially contracted configuration and advancable along arcuate, diverging paths to define a surface which non-traumatically engages the pericardium to compress the heart when advanced against the pericardium. The struts 16 may be deployed by axially reciprocating the shaft 14, typically by manually grasping and moving a handle 20 at the proximal end of the shaft 14.

The struts 16 will typically be composed of a resilient material, more typically be composed of a shape memory alloy, such as nickel titanium alloy, and will usually be formed to deploy radially outwardly and advance along the desired arcuate, diverging paths as they are advanced from the constraining sheath 12. The struts 16 may be advanced and retracted relative to the sheath 12 using the shaft 14 which reciprocates together with the struts 16 through a lumen of the sheath 12. In some instances, it will be desirable to provide at least some of the struts 16 with a temperature-responsive memory so that the shape of the struts 16 will change in response to a transition from room temperature to body temperature and/or in response to an induced temperature change after they have been deployed, e.g., by electrically heating or cooling the struts and/or infusing a heated or cooled medium into the space surrounding the struts.

The geometry of the retracted strut configuration will be selected to facilitate introduction through the intercostal space before strut deployment. Preferably, the struts 16 will be contracted within a space having a maximum width of 2 cm, preferably a maximum width of 1.2 cm. After deployment by advancing the struts 16 along the arcuate, diverging paths, a heart-engaging surface which is defined will have a surface area of at least 5 cm², preferably being in the range from about 10 cm² to 100 cm², usually in the range from 20 cm² to 75 cm². Usually, the surface will be generally circular or slightly oval with a diameter or average diameter in the range from 3 cm to 18 cm, preferably from 5 cm to 10 cm.

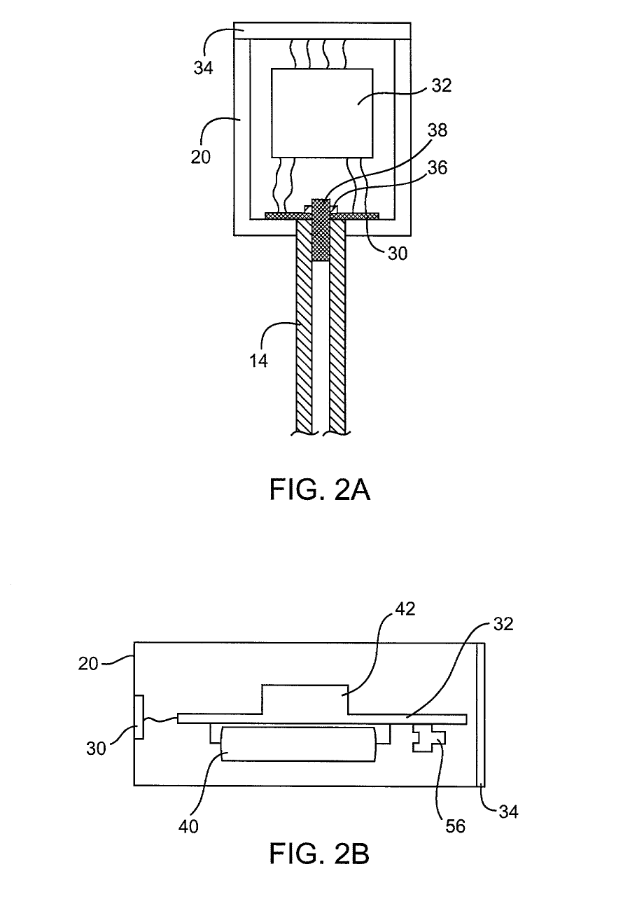

Referring now to FIG. 2A, the force transducer 30 comprises a resistive device, such as a strain gauge, which converts the amount of force applied by a treating individual through the handle 20 to the heart into an electric variation or signal. It will be appreciated that accelerometers and pressure transducers may also be suitable to determine force applications of the cardiac massage device. The force transducer 30 may be positioned inside the hollow handle 20, as shown in FIG. 2A, by a bolt 36 and screw 38 assembly. Alternatively, the force transducer 30 may be externally connected to the handle 20 or shaft 14 to measure a force applied through the handle 20 to the heart.

Referring now to FIG. 2B, the signal processor 32, which receives the force transducer signal through hard wires, will usually comprise a digital processor, an analog processor, or a high voltage amplifier. The signal processor 32 may be powered by a 3 V lithium battery 40 or other suitable power source. The power source 40 may be automatically turned on when the applied force exceeds a given threshold force, the threshold force ranging from 0.1 lbs. to 15 lbs., and automatically turned off after a period of device non-activity, typically after 15 minutes, so as to limit any wasted battery use.

The signal processor 32 will further comprise other circuitry or software 42, such as EPROM and timer chips, that compares the applied force to an optimal force value and produces a feedback message to increase, decrease, or maintain the applied force. Optimal force application values for minimally invasive direct cardiac massage will preferably be in a range from 5 lbs. to 15 lbs., more preferably from 8 lbs. to 12 lbs. The circuitry or software 42 may additionally process the force transducer signal to produce a heart compression rate signal. The circuity 42 may further compare the applied compression rate to an optimal compression rate value, and produce a feedback message to increase, decrease, or maintain the applied compression rate. Optimal compression rate values will preferably be in a range from 60 bpm to 120 bpm, more preferably from 80 bpm to 100 bpm. In some instances, a multiple array of force transducers 30 may be coupled to the handle 20 (not shown) to produce multiple force transducer signals. The signal processor 32 in turn receives and processes such signals and produces a feedback message to adjust or maintain a location or angle of force application.

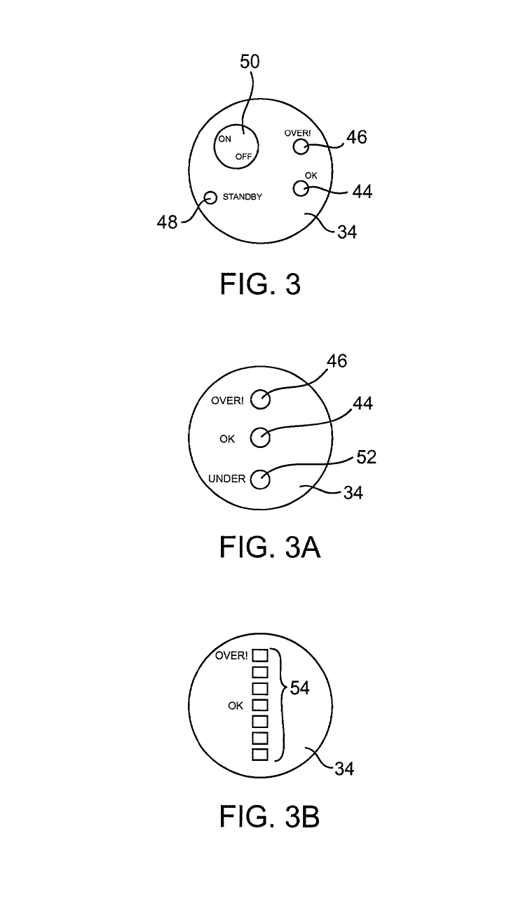

Referring now to FIG. 3, the display 34 receives feedback messages from the signal processor 32 and produces a human decipherable indication based on the feedback messages to let the treating person immediately know whether too high, too low, or acceptable force and/or compression rates are being applied, and/or whether the location and/or angle of force application is correct. The human decipherable indication may be LED (light emitting diode) lights, as shown in FIG. 3, wherein a green light 44 indicates that adequate forces are being applied, a red light 46 indicates that excessive forces are being applied, and a yellow light 48 indicates that the device 10 is on a standby mode ready for use. The display 34 may further comprise an on/off trigger 50 for the signal processor 32. FIGS. 3A and 3B illustrate alternative ways to display the feedback messages. For example, the display 34 may simply consist of three lights indicating too high 46, too low 52, or acceptable 44 force application, as depicted in FIG. 3A. The display 34 may optionally comprise a series of three of more lights 54 that indicate when the minimum force has been reached and when maximum force is exceeded, as depicted in FIG. 3B. Those skilled in the art would appreciate that the output from the signal processor 32 may be displayed in any number of alternative ways, including discrete value digital readouts, flashing lights, or a sound system, such as an audible alarm, a pacing signal, or voice commands. In some embodiments, it may also be desirable to provide a more advanced monitoring display or readout on the handle (not illustrated) which can display a variety of other patient status information to the person performing cardiac massage. Patient status information includes heart rate, minute ventilation, temperature, blood pressure, respiratory rate, and other vital signs.

Hence, the devices and methods of the present invention give a perceptible indication when appropriate compression forces and/or compression rates are applied, thereby minimizing the possibility that insufficient or excessive compression strokes are being applied during a given cardiac massage procedure. Another advantage of the present invention is that the device may be used by persons of minimal experience or training, while still allowing for control and optimization of cardiac massage performance by the treating person within the correct operating parameters (force, compression rate, etc.). Moreover, the use of such electronic monitoring provides an enhanced tactile feel to a treating person, as conventional mechanical gauges employing a compressible member often lack compliance, thereby impeding any tactile feedback.

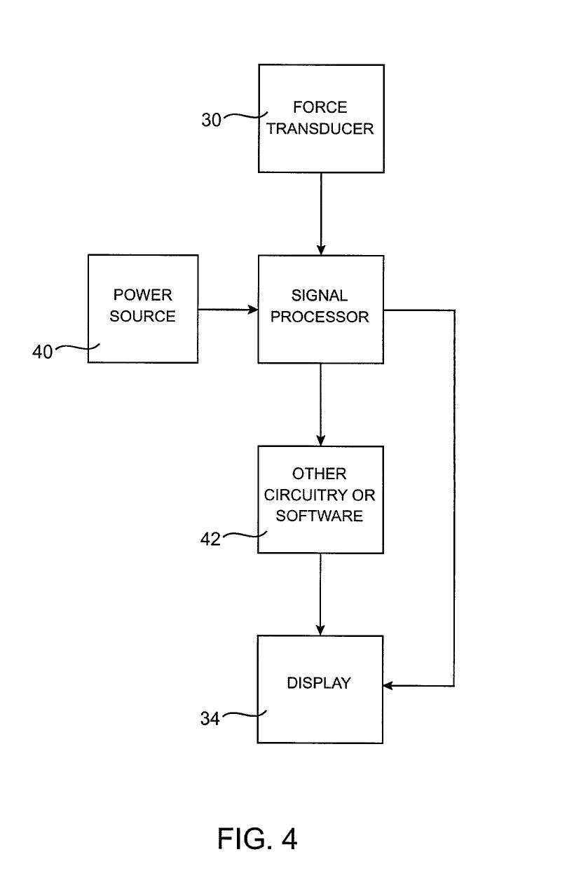

Referring now to FIG. 4, a flow chart for the electronic monitoring system of the device of FIG. 1 is illustrated. The force transducer 30 produces a signal dependent on the amount of force applied through the handle to the heart. The signal processor 32, which is powered by a battery 40, receives the force transducer signal and may automatically produce an output corresponding to the applied force directly to the display 34. Optionally, other circuitry or software 42 may compare the applied force to an optimal force value and produce a feedback message to the display 34.

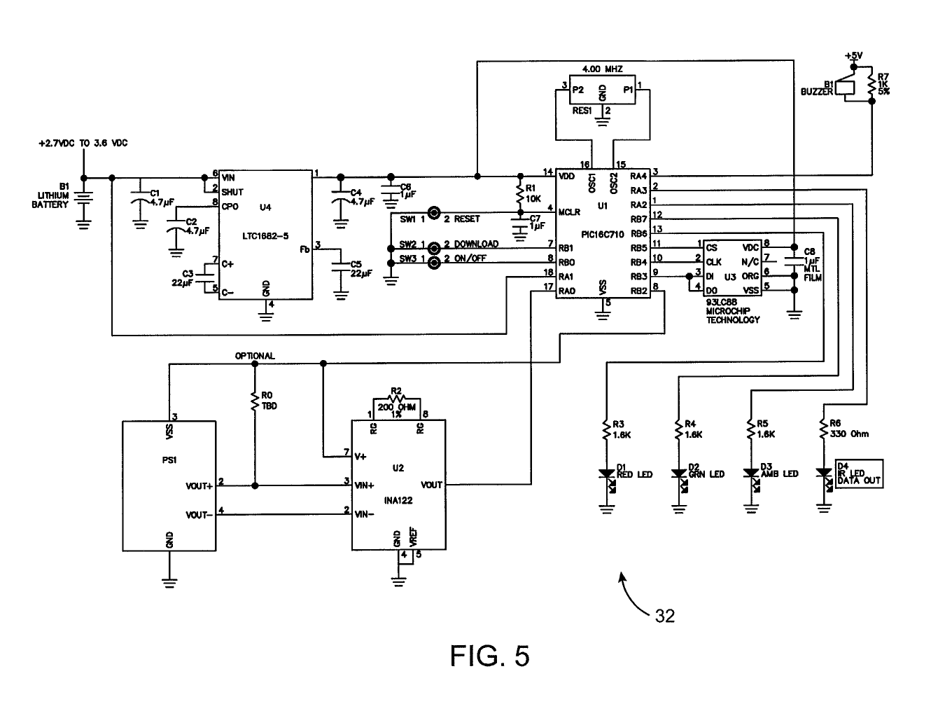

Referring now to FIG. 5, a circuit diagram of the signal processor 32 is illustrated. The signal processor 32 comprises a microprocessor that samples and stores output signals from the force transducer 30. The circuitry or software 42, in this case EPROM and timer chips, of the signal processor 32 contain program instructions for feedback determinations. The circuity or software 42 may further store data on at least one of applied force, compression rate, time intervals of device use, time intervals of device non-use, total time of device use, time of device use at a given force, and time of device use at a given compression rate. Typically, the circuitry or software 42 samples the data (i.e. does not digitize every signal) to produce a reduced data set so as to maximize memory as the memory chips have limited memory due to device size constraints. For example, memory may be triggered once a threshold force is reached. The stored data may be transmitted via infra-red, magnetic means, hard wire means, or radio frequency to an external memory source, or the stored data may be alternatively cleared by a reset button or switch 56 (FIG. 2B). Indicator LED's and a buzzer provide immediate feedback to an operator of the device.

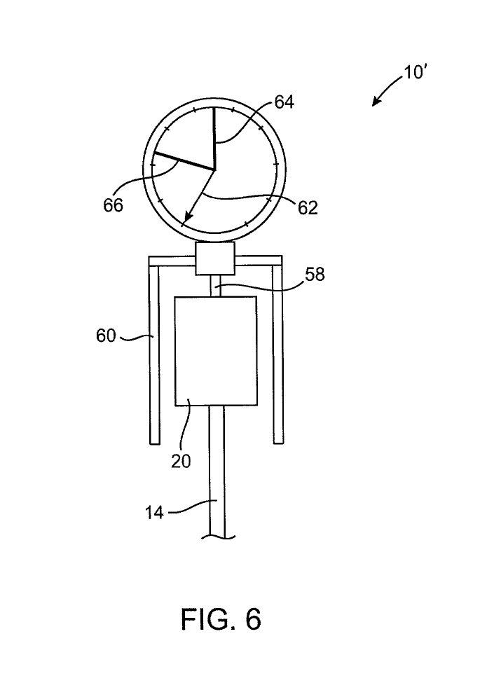

Referring now to FIG. 6, an alternate embodiment of the direct cardiac massage device 10′ constructed in accordance with the principles of the present invention is illustrated. The device 10′ may comprise a handle 20, a structure attached to one end of the handle to non-traumatically engage the pericardium to compress the heart, and a force gauge 58 coupled to the handle to measure an amount of force applied through the handle to the heart. The force gauge 58 comprises a mechanical force gauge, such as a spring or other compressible member, that is externally connected to the handle 20 by a force gauge handle 60. The force gauge handle 60 is hollow and fits over at least a part of the device so that the force gauge 58 comes in contact with the device handle 20. A dial indicator 62 is attached to the force gauge 58 to indicate an applied force to the heart. The dial indicator 62 has a maximum force limit indicator 64 set at about 12 lbs. and a minimum force limit indicator 66 set at about 8 lbs.

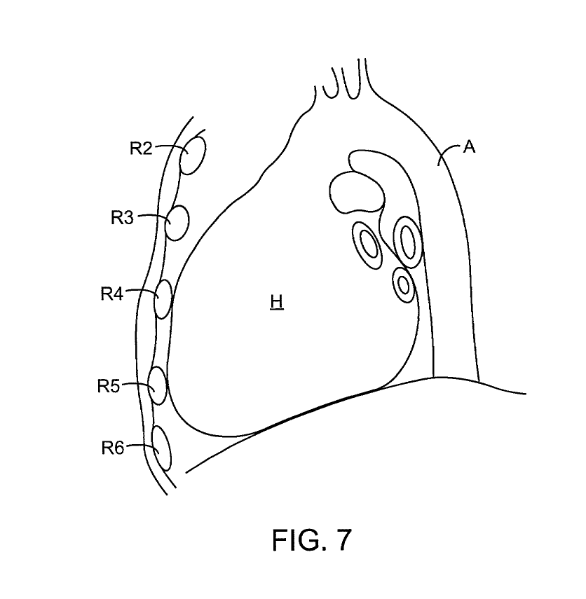

Referring now to FIG. 7, a patient's heart H is shown in cross-section between ribs Rₙ where n indicates the rib number. The aorta A is also shown extending from the top of the heart.

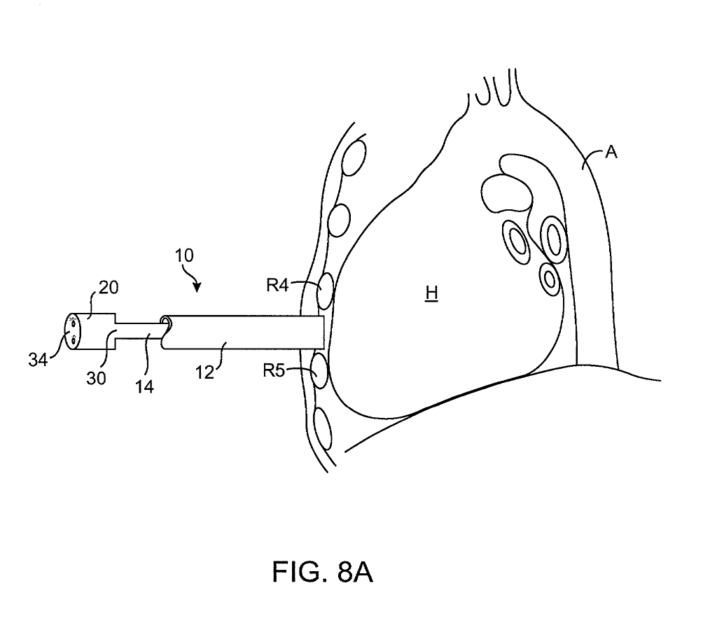

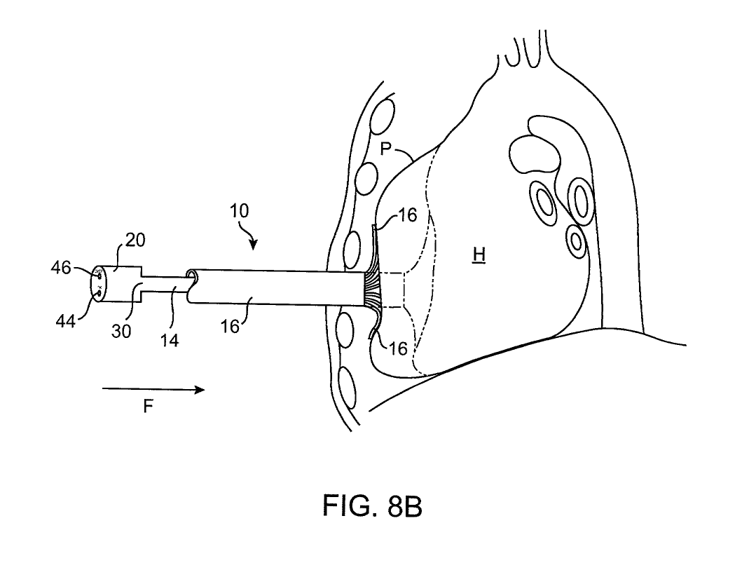

Referring now to FIGS. 8A and 8B, an exemplary method for monitoring performance of minimally invasive direct cardiac massage with the device of FIG. 1 will be described. The plurality of struts 16 of the cardiac massage device 10 are advanced in a posterior direction through an intercostal space between R₄ and R₅ to a region over a pericardium, as shown in FIG. 8A. Usually, the structure will have a contracted profile configuration when introduced through the intercostal space. Intercostal access may be established by blunt dissection, sharp dissection, or a combination of sharp and blunt dissection. The struts 16 are opened along arcuate, radially diverging paths, as shown in FIG. 8B. The cardiac massage device 10 is engaged against the pericardium P, and the device 10 as a whole may be reciprocated through the intercostal space to periodically compress the heart H, as shown in broken line. An amount of force F applied by the structure to the heart H is then monitored. Monitoring may be carried out by an electronic or mechanical force gauge.

Although certain preferred embodiments and methods have been disclosed herein, it will be apparent from the foregoing disclosure to those skilled in the art that variations and modifications of such embodiments and methods may be made without departing from the true spirit and scope of the invention. Therefore, the above description should not be taken as limiting the scope of the invention which is defined by the appended claims.

What is claimed is:

1. A minimally invasive direct cardiac massage device comprising:
a handle;
a structure attached to one end of the handle adapted to contact a pericardium or heart surface to compress the heart;
a force transducer coupled to the handle or structure to produce a signal which corresponds to an amount of force applied through the handle to the heart;
a signal processor which receives the force transducer signal and produces an output corresponding to the applied force; and
a display which receives the output of the signal processor and produces a human decipherable indication based on the applied force.

2. A device as in claim 1, wherein the structure comprises an expandable surface having a radially contracted configuration that permits intercostal passage and a radially expanded configuration for contacting the pericardium or heart surface.

3. A device as in claim 2, wherein the expandable surface has a width no greater than 2 cm in its radially contracted configuration.

4. A device as in claim 1, wherein the signal processor comprises circuitry or software that compares the applied force signal to an optimal force value and produces a feedback message to increase, decrease, or maintain the applied force.

5. A device as in claim 1, wherein the signal processor comprises circuitry or software that converts the force transducer signal to a heart compression rate signal.

6. A device as in claim 5, wherein the circuitry or software compares the applied compression rate signal to an optimal compression rate value and produces a feedback message to increase, decrease, or maintain the applied compression rate.

7. A device as in claim 1, wherein the force transducer comprises a multiple array of force transducers.

8. A device as in claim 7, wherein the signal processor comprises circuitry or software that receives the force transducer signals and produces a feedback message to adjust or maintain a location or angle of force application.

9. A device as in any one of claims 4, 6, or 8, wherein the display receives the feedback message and produces a human decipherable indication based on the feedback message.

10. A device as in claim 1, wherein the force transducer is inside the handle.

11. A device as in claim 1, wherein the force transducer is external to the handle.

12. A device as in claim 1, wherein the signal processor comprises a digital processor, an analog processor, or an amplifier.

13. A device as in claim 1, further comprising a power source coupled to the signal processor.

14. A device as in claim 13, wherein the power source is automatically turned on when the applied force exceeds a threshold force.

15. A device as in claim 13, wherein the power source is automatically turned off after a period of non-activity.

16. A device as in claim 1, wherein the signal processor comprises circuitry or software that stores data on at least one of applied force, compression rate, time intervals of device use, time intervals of device non-use, total time of device use, time of device use at a given force, and time of device use at a given compression rate.

17. A device as in claim 16, wherein the circuitry or software samples the data to produce a reduced data set.

18. A device as in claim 17, wherein the circuitry or software transmits the reduced data set via infra-red, magnetic means, hard wire means, or radio frequency.

19. A device as in claim 16, wherein the circuity or software has a reset button to clear stored data.

20. A device as in claim 1, wherein the human decipherable indication is visual.

21. A device as in claim 1, wherein the human decipherable indication is an audible alarm.

22. A device as in claim 1, further comprising an on/off trigger on the display.

23. A minimally invasive direct cardiac massage device comprising:
a handle;
a structure attached to one end of the handle adapted to non-traumatically engage a pericardium or heart surface to compress the heart; and
a force gauge coupled to the handle or structure to monitor an amount of force applied through the handle to the heart.

24. A device as in claim 23, wherein the force gauge comprises an electrical force transducer.

25. A device as in claim 23, wherein the force gauge comprises a mechanical force gauge.

26. A device as in claim 23, wherein the force gauge is external to the handle.

27. A method for monitoring performance of minimally invasive direct cardiac massage, the method comprising:
advancing a cardiac massage device through an intercostal space to a region over a pericardium;
engaging a structure on the cardiac massage device against the pericardium to periodically compress the heart; and
monitoring an amount of force applied by the structure to the heart.

28. A method as in claim 27, wherein monitoring comprises providing an electronic signal from a force transducer coupled to the cardiac massage device to a signal processor and producing a signal which corresponds to the applied force.

29. A method as in claim 28, further comprising producing a human decipherable indication based on the applied force signal.

30. A method as in claim 28, further comprising comparing the applied force signal to an optimal force value and producing a feedback message to increase, decrease, or maintain the actual applied force.

31. A method as in claim 28, further comprising processing the applied force signal to produce a heart compression rate signal.

32. A method as in claim 31, further comprising comparing the applied compression rate signal to an optimal compression rate value and producing a feedback message to increase, decrease, or maintain the actual applied compression rate.

33. A method as in claim 28, further comprising analyzing the applied force signal and producing a feedback message to adjust or maintain a location or angle of H force application.

34. A method as in any one of claims 30, 32, or 33, further comprising producing a human decipherable indication based on the feedback message.

35. A method as in claim 28, further comprising storing data on at least one of applied force, compression rate, time intervals of device use, time intervals of device non-use, total time of device use, time of device use at a given force, and time of device use at a given compression rate.

36. A method as in claim 35, further comprising sampling the data to produce a reduced data set.

37. A method as in claim 36, further comprising transmitting the reduced data set via infra-red, magnetic means, hard wire means, or radio frequency.

38. A method as in claim 27, wherein the monitoring is carried out by a mechanical force gauge.

39. A kit comprising:
a minimally invasive direct cardiac massage device; and
instructions on how to monitor performance of the direct cardiac massage device according to any one of claims 27-38.
